(19) United States
(12) Patent Application Publication
(10) Pub. No.: US 2023/0346636 A1
(43) Pub. Date: Nov. 2, 2023

(54) GARMENT WITH MASSAGING VIBRATING DEVISE MECHANISM

(71) Applicant: Juliet P. Graham, Stratford, CT (US)

(72) Inventor: Juliet P. Graham, Stratford, CT (US)

(21) Appl. No.: 16/823,236

(22) Filed: Mar. 18, 2020

Related U.S. Application Data
(60) Provisional application No. 62/919,557, filed on Mar. 18, 2019.

(51) Int. Cl. A61H 23/02; A41D 13/005; A61H 7/00; A61H 15/00; A61H 9/00; A61H 39/04; A61H 23/00; A61H 15/02

(52) U.S. Cl. CPC A61H 23/02; A41D 13/0051; A61H 7/007; A61H 15/0078; A61H 9/0092; A61H 39/04; A61H 23/006; A61H 15/02; A41D 2400/322; A61H 2201/165; A61H 2201/0207; A61H 2201/0107; A61H 2201/5097; A61H 2201/5023

(57) ABSTRACT

Disclosed is a wearable apparatus and method that provides the benefits of a Portable Massager, Exerciser & Circulation Machine for strengthening, rejuvenating all areas of the body from neck to ankles. The invention is the combination of garments interconnecting with massaging devises, creating a Full Body Massage Mechanism that enhances health, fitness and wellness. The Garments are equipped with varying Massage Types and Intensity, including Heating Therapy, Air Compression, Bi-Directional Rolling/Kneading apparatus, and mini vibrators/massagers embedded in strategic parts of the Garments, to provide the maximum effect to the various Pressure Points of the user's body. The Deep Penetration Jacket is the foundations for Deep Kneading, Rolling, and Percussion Massages. Benefits to the users of the invented, are relief from aches and pains, muscle cramps, stress, stimulation of circulation, assisting in the improvement and regeneration of some conditions, includes aiding in the betterment of other physical limitations.

### BACKGROUND

### (A) Field of the Invention

This invention is directed/relates generally to the health and wellness and exercise field, especially for those in need of Body Massage, Stress Relief, Soothing sore and achy muscles, Rejuvenating and Strengthening Neck, Waist, Legs, Shoulders, Back, Arm, Calves and other various kinds of relieves.

### (B) BACKGROUND

There are various vibrating and exercising devices that are available to date. However, there remains a continuing need for which the Garment with Full Body Massaging/Vibrating Devise Mechanism will be the solution for the relevant consumer audience.

### BRIEF SUMMARY

I have invented a new, original, non-obvious, useful and ornamental product for the purpose of health, fitness and wellness.

The designed is a wearable garment/apparatus/device and method for relieving, relaxing, massaging, stimulating, energizing, strengthening, soothing, providing overall rejuvenation to the entire body.

Among the many benefits to the users of the invented, are relief from aches and pains, muscle cramps, body stress, tiredness, strengthening, stimulation of circulation, tension, balance, and other needed enhancements, include aiding in the improvement of some physical limitations. Benefactors of the invented includes, but are not limited to, long sitting office and other workers, the elderly, the young, athletes, the fatigued and many others.

Within our bodies are numerous Pressure Points through which we may relieve our aches and pains, bringing us much needed comfort. The Garments with Massaging, Vibrating Devise/Mechanism, will benefit the user through the stimulation of all the pressure points in the user's body. Massage produces a chain reaction in the body that results in a better health condition for the user.

Utilizing the Garments with Massaging, Vibrating Devise/Mechanism will reduce stress and anxiety levels; Improve circulation; Relax & strengthen body muscles; and Soothes aches and pain; especially for Athletes, tired hard workers, persons with some physical limitations, and those who are elderly.

The Garments with Massaging, Vibrating Devise/Mechanism will improve the health and wellness of the User, providing them overall rejuvenation, and assisting in the regeneration of other conditions.

### Vibration Connection˜Pressure Points

The vibrating, massaging wearable devise, is created with Micro Mini Vibrators connected and embedded in strategic parts of the Garment, to allow for the closest, maximum effect to the various Pressure Points of the User's body.

### The Selected Areas for Full Body Impact are as Follows:

Neck, Shoulders, Hand, Waist, Ankles, Knees, Arms, Abdomen, Back, Legs, Thighs.

### DETAILED DESCRIPTION OF THE INVENTION

The invented is the combination of the Garments with Massaging, Vibrating Devise/Mechanism to create a Full Body Massaging Apparatus.

These inventions may be embodied in different forms. They should not be construed as being limited to the embodiments set forth herein.

The disclosures are for exemplifying the invention, and not for limiting the invention to the specifics of the illustrations described below; Some, but not all embodiments of the invention are shown in these figures.

The Garments with Massaging, Vibrating Devise/Mechanism is created out of the appropriate Stretchable, Breathable Compression Fabrics. Each portion of the garments/components has individual benefits.

The designed is an apparatus and method for massaging/stimulating/energizing the body. Among other benefits, it provides the means of soothing and relieving stressful conditions in the body, in addition to strengthening and toning.

The invention is an apparatus for relieving sore, achy, and painful muscles, tiredness, and stimulation of circulation throughout the body.

This full body massage mechanism is created to vary in intensity and temperature.

The Inner Layer: is in the form of a close fitting leggings and long sleeve top. (A sort of second skin) created from 4-way-stretchable High Compression Fabrics, for comfort, flexibility, energetic movements and best vibration/massaging impact.

The Doubled Middle Layers: are the foundations for the Vibrating, Massaging, Heat, and Air Compression Apparatus, which is connected to the Inner & Outer Layers via Velcro/Zipper, and is Removable for Health & Hygiene purposes. The points of impact for the Vibrators/Massagers are at the placements for maximum massaging effect to the body.

The Outer Layer: is also created out of a 4-way-stretchable High Compression Fabrics, for comfort, flexibility and best vibration impact. In addition, the Outer Layer is an attractive, stylish cover for the Foundation portion of the created, which allows the user to utilize and enjoy the benefits of the designed wherever they are and in any situation.

The Attachment Jacket: The Jacket is the foundations for the Deep Kneading, Rolling, and Percussion Massage. The fourth layer in this garment has an extra firm/strong/supportive/protective layer to enable the full benefit of the Rolling, kneading massage, and a top layer made from vinyl leather/vinyl rubber fabric. The vibration, massage therapy includes Air Compression/Acupressure, Rolling/Kneading, Percussion, and Heat Therapy Massages. The Garments with Massaging, Vibrating Devise/Mechanism is equipped with varying Massage Types and Intensity Settings, which provides the user with the ability to choose, including Auto Programs and User's own personalized programmed Choice.

The operative parts of the Garments with Massaging, Vibrating Devise/Mechanism is located at the lower/end region of the top portion of the garment, and extends to the pertaining portions of the garments. It includes the Heating Elements, the Air Compression/Acupressure Motor, the stimulating vibration devices, and the Bi-Directional Rolling/Kneading apparatus.

The Manual Control unit consist of all operable selections. As well as, the garments have both auto and manual working abilities, and is also controlled via wireless remote control and a massage app for modernized electronic connections.

The Garments with Massaging, Vibrating Devise/Mechanism are wearable devices that provides the benefits of a portable full body Massager, Exerciser & Circulation Machine.

It includes vibration massage, deep kneading/rolling massage, air compression/acupressure massage, percussion massage and heating therapy.

FIG. 1 is an example of the outer frontal view of the Garments with Massaging, Vibrating Devise/Mechanism which includes the placement of the charging connection, the control device, logo, and connectors. (See 301,302,303 and 304)

FIG. 2 illustrates a view of the outer layer of the back portion of the devise (See logo 303)

FIG. 3A depicts a front view of the hidden middle portion, the removable Multi Chambers Air Compression Devise, that is between the outer layer and the removable Vibration Heat Mechanism. (See 305 and 306)

FIG. 3B is a back view of the hidden middle portion of the removable Multi Chambers Air Compression Devise, that is between the outer layer and the removable Vibration Heat Mechanism (See 304, 305, 306, and 307)

FIG. 3C illustrates the front view of the Removable Vibration Heat Mechanism which is immediately behind the Removable Multi Chambers Air Compression Devise, and before the Protective Lining against the skin, containing the Heating and Vibrating Devises. (See 305, 308 and 309)

FIG. 3D is a view of the back of the Removable Vibration Heat Mechanism which is immediately behind the Removable Multi Chambers Air Compression Devise, and before the Protective Lining against the skin, containing the Heating and Vibrating Devises. (See 305, 308, 309, 310 and 311)

FIG. 4A-B illustrates a front view of the Protective Lining against the skin, indicating velcro/zipper connections for stabilizing positions of the removable Air Compression/Heat Mechanism doubled middle layers (See 305 and 314)

FIG. 5. is a view of the back of the Protective Lining against the skin, indicating velcro/zipper connections for stabilizing positions of the removable Air Compression/Heat Mechanism doubled middle layers (See 305)

FIG. 6A-C is a Schematic of the Middle Layer of the Deep Penetration Jacket, both front and back, with a view of the positioning of the elements inside the apparatus. (See 301, 302, 305, 308, 309, 310, 311, 314, 315, & 316)

FIG. 7. depicts a diagram of the Roller Deep Kneading Apparatus, emphasizing the Bi-directional, Rotating, Massaging heads. (See 315, 316 and 317)

FIG. 8A-B illustrate the front and back Pressure Points Placements

The User is able to choose between various massage types. Deep Kneading, Vibration, Heat, Compression/Acupressure, Percussion, Rolling, Auto Program and User's Choice. The Adjustable levels of intensity allows the user to select their individual desire for comfort and relaxation in their massage. User may utilize only one of each available options, or choose a combination to customize their own massage program.

### BRIEF DESCRIPTION OF THE DRAWING

The accompanying drawings are not necessarily drawn to scale.

Embodiments of the invention are illustrated as examples and are not limited by the figures of the accompanying drawings.

FIG. 1 illustrates a front view of the outer layer of the Garments with Massaging, Vibrating Devise/Mechanism

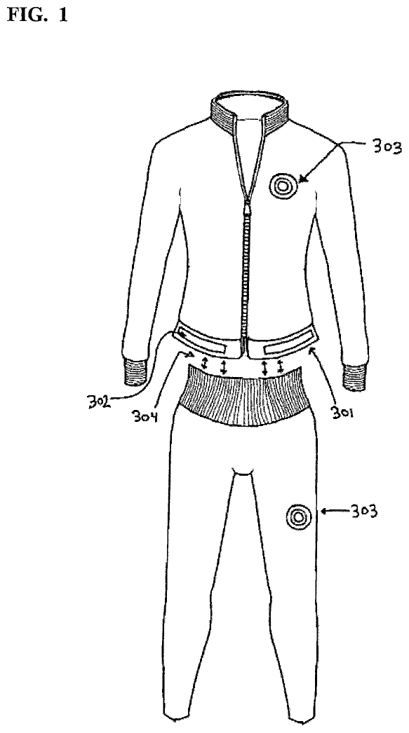

FIG. 2 illustrates a back view of the Garments with Massaging, Vibrating Devise/Mechanism

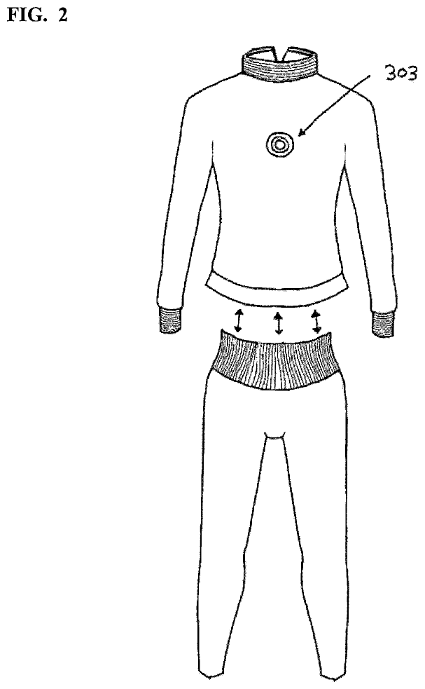

FIG. 3A illustrates a front view of the Removable Multi Chambers Air Compression Devise

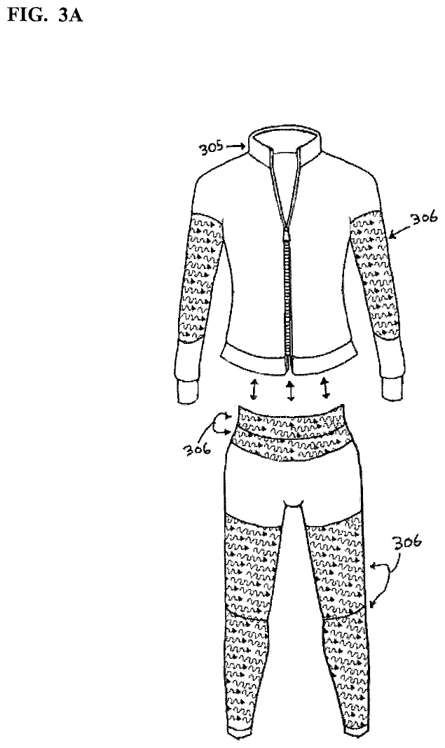

FIG. 3B illustrates a back view of the Removable Multi Chambers Air Compression Devise

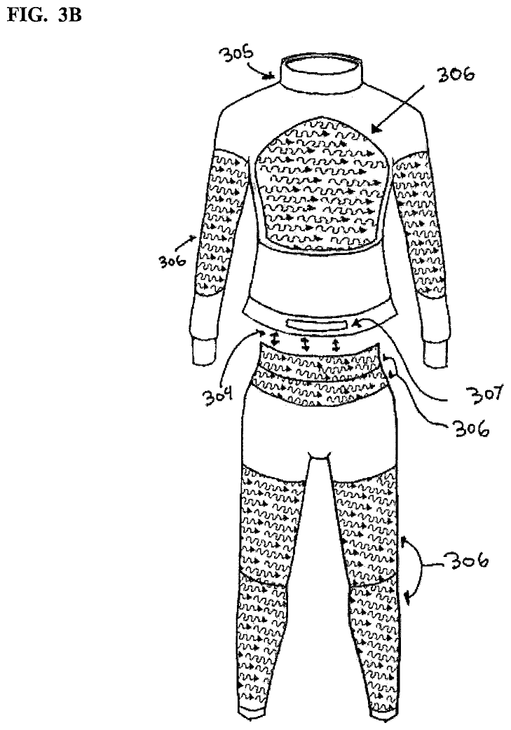

FIG. 3C depicts a front view of the Removable Vibration Heat Mechanism

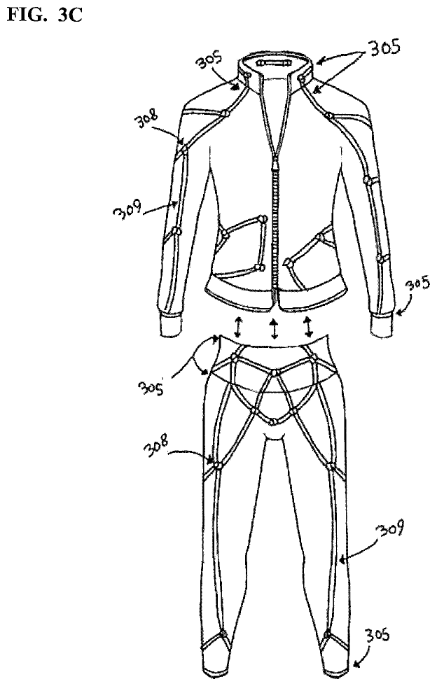

FIG. 3D illustrates the back view of the Removable Vibration Heat Mechanism

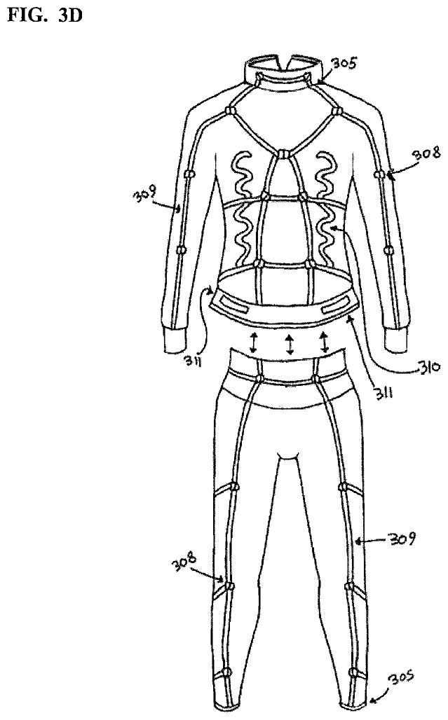

FIG. 4A-B illustrates the front view of the Protective Lining against the skin

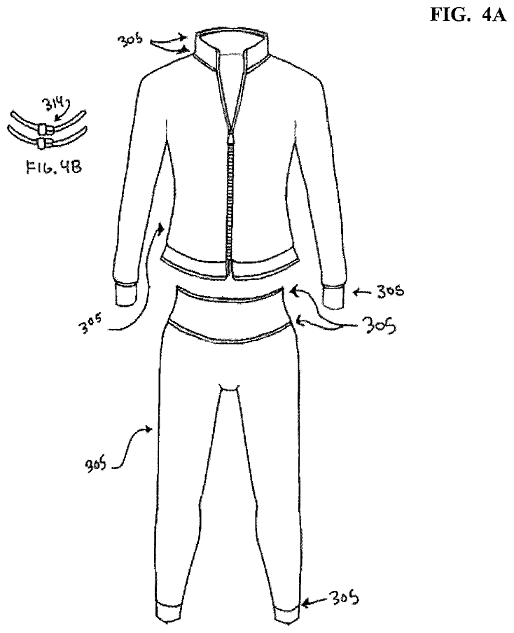

FIG. 5 illustrates the back view of the Protective Lining against the skin

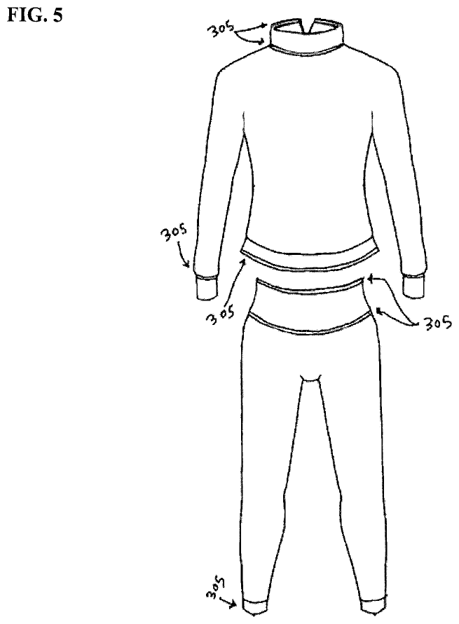

FIG. 6A-C illustrates both the front and back views of the Schematic of the Deep Penetration Jacket

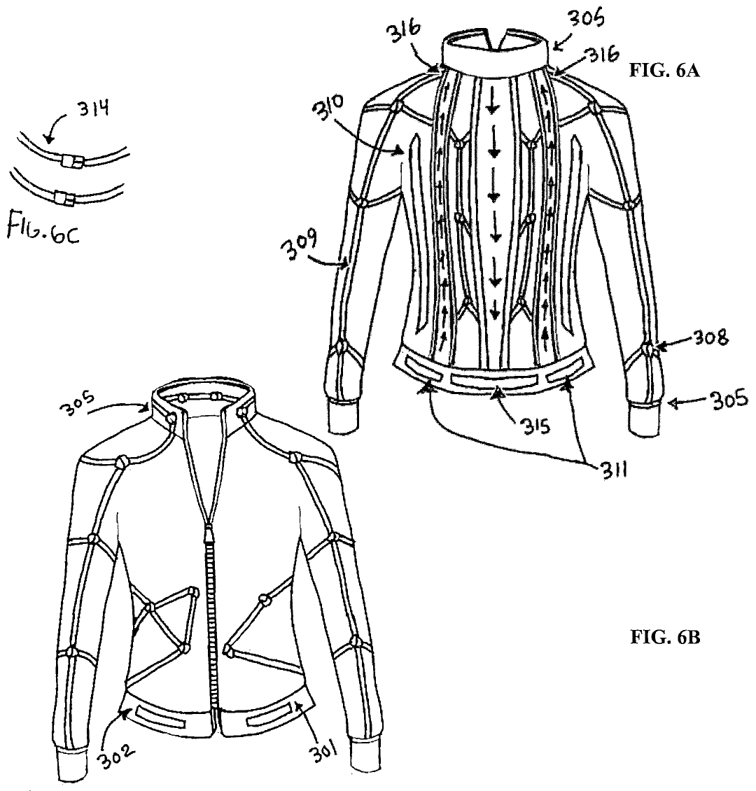

FIG. 7 depicts a view of the Roller Deep Kneading Apparatus.

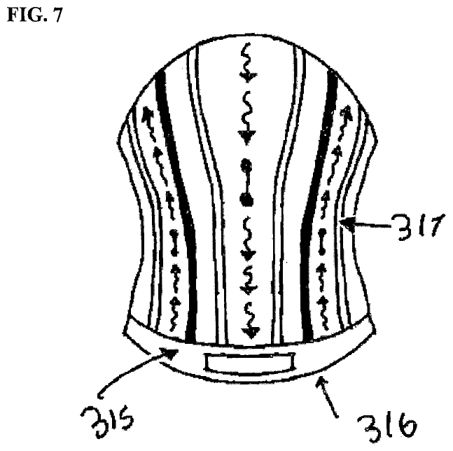

FIG. 8A-B is a diagram of a Pressure Points Placements

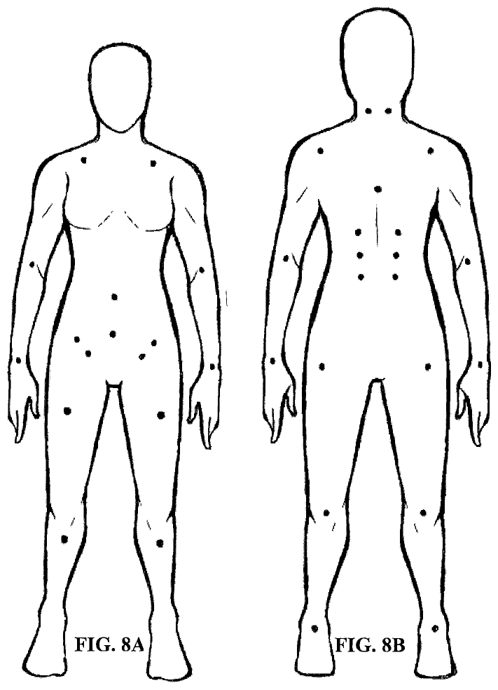

### REFERENCE CHARACTERS

301 Manual Control
302 Charging Station
303 Logo
304 Connectors
305 Zipper/Velcro Connection
306 Wrap-Around Air Flow Chamber
307 Air Compression Devise
308 Vibrating Devises
309 Lead Wire
310 Heating Devise
311 Heat Vibration Mechanism Connectivity
314 Inside Tighteners/Adjusters
315 Heat Vibration Rolling Mechanism Connectivity
316 Bi-Directional Rolling/Kneading Apparatus
317 Bi-Directional Rotating Massaging Heads

### CONCLUSION

Be it known that many verifications and modifications of the disclosed embodiments may affect the spirit and scope of the described invention.

What I claim is:

1. The invention of The Garments with Massaging, Vibrating Devises/Mechanisms and the Deep Penetration Jacket are Non-Restrictive, Full Body massaging, vibrating machines.

2. The Garments with Massaging, Vibrating Devises/Mechanisms and the Deep Penetration Jacket as is claimed in claim 1 are wearable devices that provides the benefits of a portable whole body Massager, Exerciser & Circulation Machine.

3. The Deep Penetration Jacket: as is claimed in claim 2 is equipped with rolling/deep kneading, heating and vibrating devices for the added benefits of toning and strengthening, made from Synthetic Leather, Vinyl Rubber or other appropriate materials.

4. The Deep Penetration Jacket: as is claimed in claim 2 has multiple Bi-Directional rotating massage heads that provides full-coverage massaging pressure to the back, from high neck to below waist and encompasses up to four levels of intensity and up to six choices of motions.

5. The Deep Penetration Jacket: as is claimed in claim 3 is an apparatus having up to three rows of roller/kneading knob tracks, with the center track longest, extending up into the neck region, and one on the right and left side of the center track, with both being the same length extending up to the shoulders

6. The Deep Penetration Jacket: as is claimed in claim 5 has included in the back portion, a protective layer of lightweight unbreakable or composite material, with the Motor Holder for connecting to the three knob tracks located at the lower end of the Massaging-Vibrating Jacket, and the back Pressure Points Schematic placed on the inside of the jacket,

7. The Deep Penetration Jacket: as is claimed in claim 6 is created with the heat and vibration devices on both sides of the roller/kneading knob tracks, with heating and vibrating operation all through-out the entire jacket, front and back.

8. The Garments with Massaging, Vibrating Devises/Mechanisms as is claimed in claim 1 is equipped with a removable, up to nine Chambers Air Compression Devise, and a Removable Vibration/Heat Mechanism that creates a doubled middle layer, and is secured in place by zippers and velcro, with motors/connectivity located in Compartments along the lower back, and Manual Controls and Charging Stations along the lower front.

9. The Garments with Massaging, Vibrating Devises/Mechanisms as is claimed in claim 5 provides wrap around Air Compression/Acupressure that inflates and deflates, beginning slowly and gradually increasing to the strength of the desired setting and is comprised of up to four different Settings that supplies the arms, waist, legs and back with added massaging pressure.

10. The Garments with Massaging, Vibrating Devises/Mechanisms as is claimed in claim 5 provides wrap around Air Compression/Acupressure that inflates and deflates, beginning slowly and gradually increasing to the strength of the desired setting and is comprised of up to four different Settings that supplies the arms, waist, legs and back with added massaging pressure.

11. The Garments with Massaging, Vibrating Devises/Mechanisms as is claimed in claim 5 has a Heating Element located at the back of the garment on each side of the Vibration devises, that is used to supply heat throughout the garment, with Heat and Vibration Therapy flowing from high neck to low ankles, and has three levels of varying temperature adjustments.

12. The Garments with Massaging, Vibrating Devises/Mechanisms as is claimed in claim 1 has a Timer Control Settings with multiple Auto Shut-Off timing options for safety, and the Heating Element is built with an Overheat Protection feature.

13. The Deep Penetration Jacket: as is claimed in claim 2 has a Percussion feature that utilizes the Bi-Directional element to move in an Up and Down hammering motion with up to six percussion heads and three setting adjustments for deep penetrating percussive therapy.

14. The Garments with Massaging, Vibrating Devises/Mechanisms as is claimed in claim 8 consists of the lead wires from the massaging adjustment manual control unit which operates the vibrators used to stimulate vibration, and has up to five manual Adjustable speed levels of vibration, up to six vibratory stimulating modes and features gradual vibration ramp-up from initial start to selected manual setting.

15. The Garments with Massaging, Vibrating Devises/Mechanisms as is claimed in claim 1 is equipped with a battery holder that is contained on the front/side of the top portion of the garment, and is energized by a Rechargeable (Lithium Ion Batteries) with up to eight hours of operation per charge.

16. The Garments with Massaging, Vibrating Devises/Mechanisms as is claimed in claim 1 positions the Manual Control unit on the front/side portion of the garment and consist of all operable selections.

17. The Garments with Massaging, Vibrating Devises/Mechanisms as is claimed in claim 1 encompasses both Auto and Manual working abilities, and is also controlled via Wireless Remote Control for portability, and Massage App for modernized Electronic connections.

18. The Garments with Massaging, Vibrating Devises/Mechanisms as is claimed in claim 1 is built with connectors for allowing modular connections.

19. The Garments with Massaging, Vibrating Devises/Mechanisms as is claimed in claim 1 encompasses up to four alternating Pre-Programmed massage techniques that automatically switches to the next technique after five minutes; with three levels of intensity and auto stop feature.

20. The Garments with Massaging, Vibrating Devises/Mechanisms as is claimed in claim 1 is created with a Protective Inner Layer Lining for comfort against the skin and to support and stabilize the removable doubled middle layer by zippers and velcro.
